(19) United States
(12) Patent Application Publication
(10) Pub. No.: US 2024/0073345 A1
(43) Pub. Date: Feb. 29, 2024

(54) IMAGE FORMING APPARATUS, NON-TRANSITORY COMPUTER READABLE MEDIUM STORING IMAGE FORMING PROGRAM, AND INFORMATION PROCESSING SYSTEM

(71) Applicant: FUJIFILM Business Innovation Corp., Tokyo (JP)

(72) Inventor: Haruhisa HOSHINO, Kanagawa (JP)

(73) Assignee: FUJIFILM Business Innovation Corp., Tokyo (JP)

(21) Appl. No.: 18/165,904

(22) Filed: Feb. 7, 2023

(30) Foreign Application Priority Data
Aug. 30, 2022 (JP) 2022-137330

(51) Int. Cl. H04N 1/32; H04L 9/40

(52) U.S. Cl. CPC H04N 1/32374; H04L 63/029; H04N 1/32416

(57) ABSTRACT

An image forming apparatus includes a processor configured to acquire supplementary information for supplementing a process instructed in an instruction sheet from a first server installed together on an inside of a firewall, execute the process instructed in accordance with the instruction sheet supplemented by the supplementary information, and transmit the supplemented instruction sheet to a second server installed on an outside of the firewall together with an image generated by the instructed process, and instruct the second server to execute an image process on the image in accordance with the instruction sheet.

### CROSS-REFERENCE TO RELATED APPLICATIONS

This application is based on and claims priority under 35 USC 119 from Japanese Patent Application No. 2022-137330 filed Aug. 30, 2022.

### BACKGROUND

### (i) Technical Field

The present disclosure relates to an image forming apparatus, a non-transitory computer readable medium storing an image forming program, and an information processing system.

### (ii) Related Art

JP6264800B discloses an information processing system including a plurality of information processing apparatuses that execute a plurality of processes defined by workflow information. The workflow information is information for defining an order of a plurality of processes and an information processing apparatus as an execution subject for each of the plurality of processes and, in which one information processing apparatus selected among the plurality of information processing apparatuses can be defined as the execution subject. Regarding the plurality of information processing apparatuses, an information processing apparatus defined as the execution subject executes each of a plurality of processes defined in the workflow information in the defined order, and one information processing apparatus selected in accordance with a predetermined determination condition executes a process having an execution subject defined to be one information processing apparatus selected among the plurality of information processing apparatuses in the workflow information. The workflow information defines a connection process between a process having an execution subject that is a first information processing apparatus and a process having an execution subject that is a second information processing apparatus. In the connection process, the first information processing apparatus transmits target data to the second information processing apparatus from the first information processing apparatus, changes the execution subject for the next process to the second information processing apparatus. After that, in a case where the connection process having a probability that the execution subject is brought back to the first information processing apparatus is included, the first information processing apparatus transitions the execution to the next connection process. In the next connection process, the first information processing apparatus receives, from the second information processing apparatus, information indicating that the execution subject is changed from the second information processing apparatus to the first information processing apparatus. In a case where the execution subject is changed to the first information processing apparatus, the target data is received from the second information processing apparatus.

### SUMMARY

A workflow process in which a plurality of devices cooperate to execute a process instructed by a user may be executed. In a case where the process executed by the workflow process is changed, it is necessary to individually change information referred to by each device in accordance with a change of information handled in the workflow process.

Therefore, for example, as the number of devices for which information is changed increases, an operation of updating information for each device in accordance with the change in the workflow process takes time.

Aspects of non-limiting embodiments of the present disclosure relate to an image forming apparatus, a non-transitory computer readable medium storing an image forming program, and an information processing system that, in a case where a plurality of devices cooperate to execute an instructed process, even though information having an influence on the content of the process has been changed, can execute a process corresponding to the changed information by changing information stored in any one of the devices.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming apparatus including a processor configured to acquire supplementary information for supplementing a process instructed in an instruction sheet from a first server installed together on an inside of a firewall, execute the process instructed in accordance with the instruction sheet supplemented by the supplementary information, and transmit the supplemented instruction sheet to a second server installed on an outside of the firewall together with an image generated by the instructed process, and instruct the second server to execute an image process on the image in accordance with the instruction sheet.

### BRIEF DESCRIPTION OF THE DRAWINGS

Exemplary embodiment(s) of the present invention will be described in detail based on the following figures, wherein:

FIG. 1 is a diagram illustrating a system configuration example in an information processing system according to a first exemplary embodiment;

FIG. 2 is a sequence diagram illustrating an example of a data flow in the information processing system;

FIG. 3 is a diagram illustrating a configuration example of a main part of an electrical system of an image forming apparatus;

FIG. 4 is a diagram illustrating a configuration example of a main part of an electrical system of a business system;

FIG. 5 is a diagram illustrating a configuration example of a main part of an electrical system of a server;

FIG. 6 is a flowchart illustrating an example of a flow of an image forming process in the image forming apparatus;

FIG. 7 is a flowchart illustrating an example of a flow of an information collection process in the business system;

FIG. 8 is a flowchart illustrating an example of a flow of an image process in the server; and

FIG. 9 is a diagram illustrating a system configuration example in an information processing system according to a second exemplary embodiment.

### DETAILED DESCRIPTION

Hereinafter, exemplary embodiments of the present disclosure will be described with reference to the accompanying drawings. The identical components and the identical processes are denoted by the identical reference signs in the drawings, and repetitive description will be omitted.

### First Exemplary Embodiment

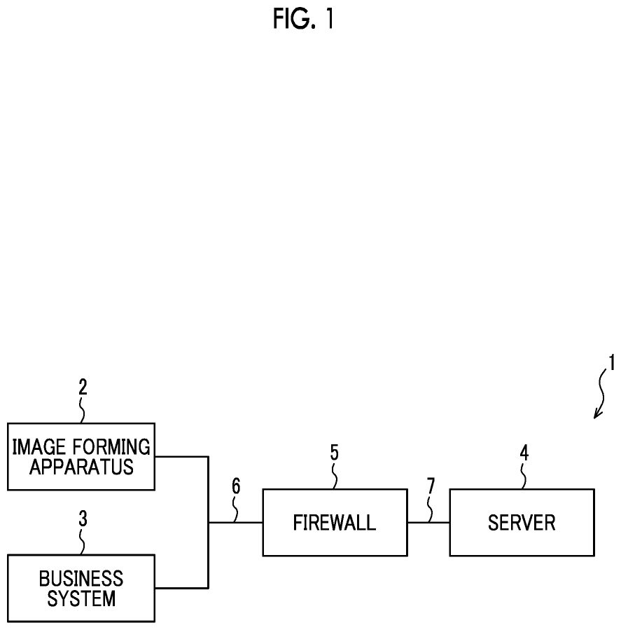

FIG. 1 is a diagram illustrating a system configuration example in an information processing system 1 according to a first exemplary embodiment. The information processing system 1 includes an image forming apparatus 2, a business system 3, a server 4, and a firewall 5. The image forming apparatus 2 and the business system 3 are connected to a communication line 6, and the server 4 is connected to a communication line 7.

For easy description, a place where the image forming apparatus 2 and the business system 3 connected to the communication line 6 are installed with the firewall 5 as a boundary is referred to as an “inside of the firewall 5”. Further, a place where the server 4 connected to the communication line 7 is installed with the firewall 5 as a boundary is referred to as an “outside of the firewall 5”. The inside of the firewall 5 corresponds to, for example, the space of a company building where a user works, and the outside of the firewall 5 corresponds to, for example, a cloud space constructed on the Internet.

The image forming apparatus 2 is an apparatus that forms an image in accordance with an instruction of a user. For example, a printer, a scanner, a copying machine, a fax device, and the like are examples of the image forming apparatus 2, and an apparatus having at least two or more functions of these devices is also an example of the image forming apparatus 2. An example in which the image forming apparatus 2 in the present disclosure includes a function of at least a scanner, and a user instructs the image forming apparatus 2 to generate an image obtained by optically scanning a document with a scanner will be described. The content of the document to be scanned by the image forming apparatus 2 is not limited, and may include figures and pictures in addition to text.

The image forming apparatus 2 provides the user with a menu of an image process such as an optical character recognition (OCR) process of performing character recognition on, for example, an image of a document in addition to an image process of simply forming an image of a document. An example in which the user instructs the image forming apparatus 2 to execute a process including the OCR process on an image of a document scanned by a scanner will be described below.

Since an image of a document has a larger data capacity than, for example, text data, in a case where the instructed image process is executed by the image forming apparatus 2, a load is applied to the image forming apparatus 2, and it may take a long time to end the image process. Therefore, the image forming apparatus 2 transmits the formed image to the server 4, and causes the server 4 to execute the image process on the image.

The server 4 is an example of a second server that receives an image from the image forming apparatus 2 and executes an image process instructed by the image forming apparatus 2 on the received image. The server 4 transmits an image after executing the instructed image process to the image forming apparatus 2. The image after the image process is executed by the server 4 is referred to as a “process image”.

The business system 3 is an example of a first server provided on the inside of the firewall 5. The business system 3 performs a business such as so-called “form organization”, in which, for example, process images of a document are collectively stored in a folder for each of the identical types, or are collectively stored in a folder for each business partner. A process executed by the business system 3 is not limited to the form organization. The business system 3 may be any one that executes other processes using the process image, such as a bookbinding process or an estimation process.

The firewall 5 restricts the access from the outside of the firewall 5 to the inside of the firewall 5. Thus, the server 4 is not permitted to directly transfer the process image to the image forming apparatus 2 and the business system 3. In this case, the server 4 transmits the process image to the image forming apparatus 2 as a response to polling from the image forming apparatus 2. Further, the server 4 is not permitted to refer to the information of the image forming apparatus 2 and the business system 3. In this case, necessary information is transmitted from the image forming apparatus 2 and the business system 3 to the server 4.

On the other hand, the firewall 5 permits an access from the image forming apparatus 2 to the server 4.

There are no restrictions on the connection forms of the communication line 6 provided on the inside of the firewall 5 and the communication line 7 provided on the outside of the firewall 5, and the connection form may be either a wireless form or a wired form, or a mixture of a wireless form and a wired form. The communication line 6 corresponds to, for example, a local area network (LAN), and the communication line 7 corresponds to, for example, the Internet.

The information processing system 1 may include a plurality of the image forming apparatuses 2, a plurality of the business systems 3, and a plurality of the servers 4.

Next, a data flow in the information processing system 1 will be described.

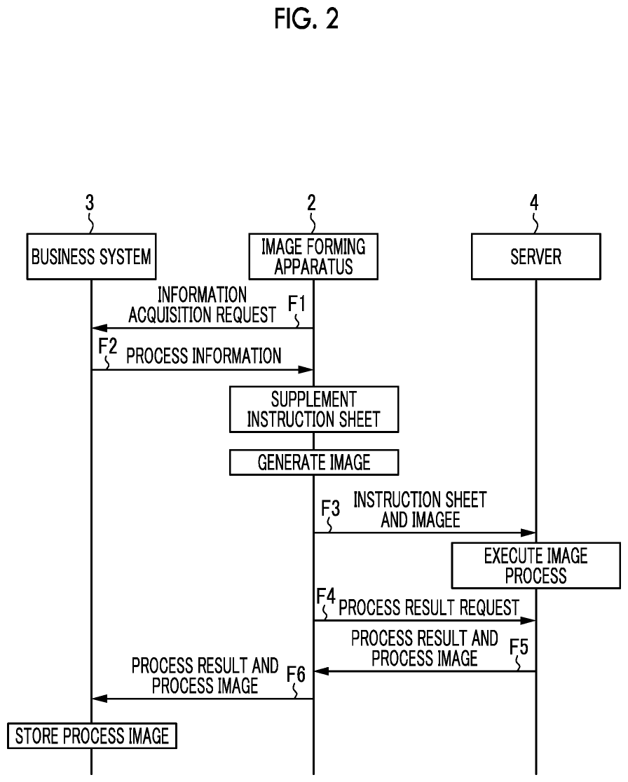

FIG. 2 is a sequence diagram illustrating an example of a data flow in the information processing system 1 in a case where the image forming apparatus 2 generates an image of a document, and the server 4 executes an image process on the generated image to generate a process image of the document and stores the generated process image in the business system 3.

First, in a case where the image forming apparatus 2 receives an instruction for a certain process from the user, the image forming apparatus 2 acquires information having an influence on the operation of the instructed process from the business system 3, and generates an instruction sheet supplemented by using the acquired information.

The instruction sheet is information in which the process content from the start to the end of a process intended to be executed by the user, in the information processing system 1, is defined. That is, the image forming apparatus 2, the business system 3, and the server 4 execute a respective predetermined process while dividing a role in accordance with the content of the instruction sheet corresponding to the process instructed by the user. Such a case where a plurality of devices included in the information processing system 1 cooperate to execute a predetermined process is referred to as a “workflow process”. Therefore, the instruction sheet is an example of information in which the content of the workflow process is defined.

The information having an influence on the operation of the process instructed by the user is information having an influence on the process executed by the image forming apparatus 2, the business system 3, and the server 4.

The image forming apparatus 2 that has generated the instruction sheet transmits an information acquisition request to the business system 3 in order to acquire the information having an influence on the operation of the process instructed by the instruction sheet, before generating the image of the document (FIG. 2: F1). The information having an influence on the operation of the process instructed by the instruction sheet includes, for example, an operation parameter of the image forming apparatus 2 and information necessary for executing the instructed process.

The operation parameter is a value having an influence on the content of the image generated by the image forming apparatus 2. For example, in a case where the image forming apparatus 2 scans a document using a scanner to generate an image of the document, the operation parameter corresponds to a value for defining a scanning operation of the scanner, such as the reading resolution of the document and a color designation for designating a mode of reading the document in black-and-white, grayscale, or color.

The information necessary for executing the instructed process includes, for example, information regarding a storage area as a candidate for a storage destination of a process image after an image process is executed on the image of the document in a case where the instructed process is form organization.

On the other hand, the business system 3 transmits process information to the image forming apparatus 2 being a transmission source of the information process request. The process information includes the operation parameters set in advance for the instructed process and the information necessary for executing the instructed process (FIG. 2: F2).

In a case where the image forming apparatus 2 receives the process information from the business system 3, the image forming apparatus 2 reflects the content of the process information in the instruction sheet of the instructed process to supplement the instruction sheet.

Then, the image forming apparatus 2 generates an image of the document after the operation parameter included in the instruction sheet is set in the image forming apparatus 2, and transmits the instruction sheet and the generated image to the server 4 (FIG. 2: F3).

The server 4 that has received the instruction sheet and the image executes the image process instructed by the instruction sheet on the received image.

On the other hand, after transmitting the instruction sheet and the image to the server 4, the image forming apparatus 2 transmits a process result request for requesting the process result of the image process to the server 4 in order to obtain the process result of the image process requested to the server 4 (FIG. 2: F4).

Regarding this, the server 4 transmits the process result of the image process and the process image obtained by executing the image process on the image to the image forming apparatus 2 as a response to the process result request (FIG. 2: F5).

The image forming apparatus 2 that has received the process result and the process image stores the process result and the process image in the storage destination of the business system 3 instructed by the instruction sheet (FIG. 2: F6). The image forming apparatus 2 may store the instruction sheet together with the process result and the process image in the instructed storage destination of the business system 3.

From the above description, the information processing system 1 ends the workflow process instructed by the user.

For convenience of description, a document storage process will be described below as an example of the workflow process in the information processing system 1. In the storage process of a document, the server 4 executes an OCR process on an image of a document obtained by scanning of the scanner provided in the image forming apparatus 2 to identify the type of the document, and stores the process image of the document of which the type has been identified, in a storage area corresponding to the type of document, which is provided in the business system 3 in advance.

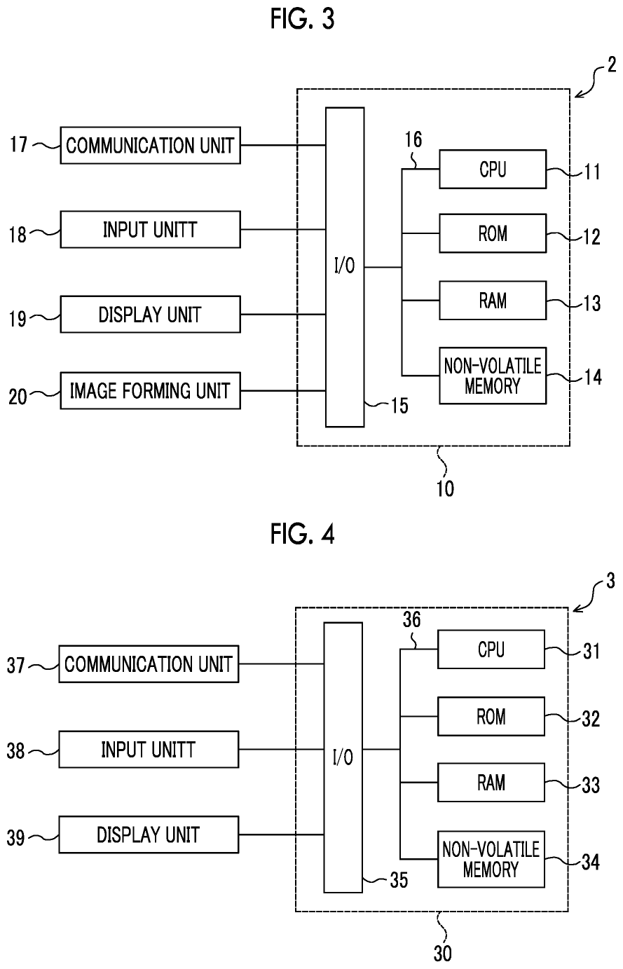

The image forming apparatus 2, the business system 3, and the server 4 that execute the workflow process can be configured by using a computer 10, a computer 30, and a computer 40, respectively. FIG. 3 is a diagram illustrating a configuration example of a main part of an electrical system of the image forming apparatus 2 configured by using the computer 10.

The computer 10 includes a central processing unit (CPU) 11 which is an example of a second processor that executes a process in the image forming apparatus 2, a read only memory (ROM) 12 that stores a startup program (Basic Input Output System (BIOS)) that executes a startup process of the computer 10, a random access memory (RAM) 13 used as a temporary work area of the CPU 11, a non-volatile memory 14, and an input/output interface (I/O) 15. The CPU 11, the ROM 12, the RAM 13, the non-volatile memory 14, and the I/O 15 are connected to each other via a bus 16.

The non-volatile memory 14 is an example of a storage device that retains stored information even though power supplied to the non-volatile memory 14 is cut off. As the non-volatile memory 14, for example, a semiconductor memory is used, and a hard disk may be used.

For example, a communication unit 17, an input unit 18, a display unit 19, and an image forming unit 20 are connected to the I/O 15.

The communication unit 17 is connected to the communication line 6 and includes a communication protocol for performing data communication with a device (for example, the business system 3 or an external device (not illustrated)) installed on the inside of the firewall 5. The communication unit 17 includes a communication protocol for performing data communication with the server 4 via the firewall 5.

The input unit 18 is an example of a unit that receives an operation of the user on the image forming apparatus 2 and notifies the CPU 11 of the operation, and includes, for example, a button, a touch panel, and a pointing device.

The display unit 19 is an example of a unit that visually displays information processed by the CPU 11, and includes, for example, a liquid crystal display and an organic electro-luminescence (EL) display.

The image forming unit 20 is a unit that forms an image. The image forming unit 20 includes, for example, a scanner unit that optically scans the contents of a document and generates an image of the document.

FIG. 4 is a diagram illustrating a configuration example of a main part of an electrical system of the business system 3 configured by using the computer 30. The business system 3 may be configured by a plurality of computers 30, but as an example, it is assumed that the business system 3 is configured by one computer 30.

The computer 30 includes a CPU 31 which is an example of a first processor that executes a process in the business system 3, a ROM 32 that stores a BIOS of executing a startup process of the computer 30, a RAM 33 used as a temporary work area of the CPU 31, a non-volatile memory 34, and an I/O 35. The CPU 31, the ROM 32, the RAM 33, the non-volatile memory 34, and the I/O 35 are connected to each other via a bus 36.

Further, a communication unit 37, an input unit 38, and a display unit 39 are connected to the I/O 35.

The communication unit 37 is connected to the communication line 6 and includes a communication protocol for performing data communication with a device (for example, the image forming apparatus 2 or an external device (not illustrated)) installed on the inside of the firewall 5.

The input unit 38 is an example of a unit that receives an operation of the user on the business system 3 and notifies the CPU 31 of the operation, and includes, for example, a button, a touch panel, a keyboard, a mouse, and a pointing device.

The display unit 39 is an example of a unit that visually displays information processed by the CPU 31, and includes, for example, a liquid crystal display and an organic EL display.

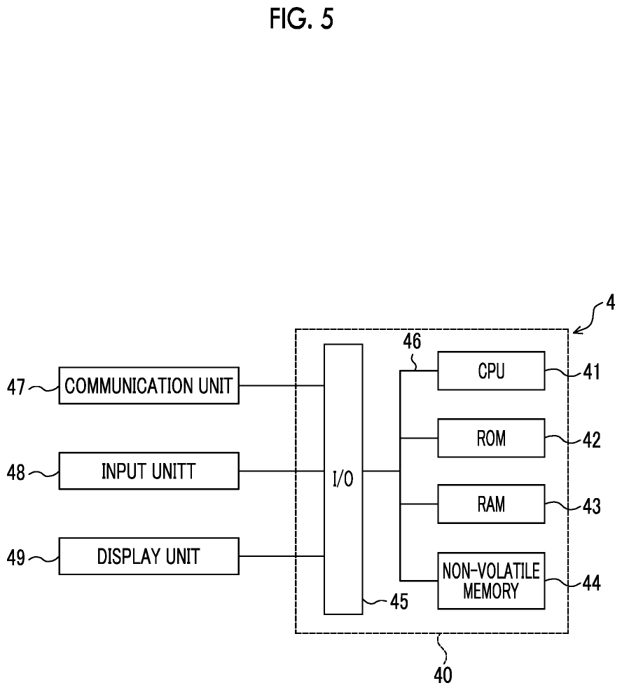

On the other hand, FIG. 5 is a diagram illustrating a configuration example of a main part of an electrical system of the server 4 configured by using the computer 40.

The computer 40 includes a CPU 41 which is an example of a third processor that executes a process in the server 4, a ROM 42 that stores a BIOS of executing a startup process of the computer 40, a RAM 43 used as a temporary work area of the CPU 41, a non-volatile memory 44, and an I/O 45. The CPU 41, the ROM 42, the RAM 43, the non-volatile memory 44, and the I/O 45 are connected to each other via a bus 46.

Further, a communication unit 47, an input unit 48, and a display unit 49 are connected to the I/O 45.

The communication unit 47 is connected to the communication line 7, includes a communication protocol for performing data communication with an external device (not illustrated) installed on the outside of the firewall 5, and includes a communication protocol for performing data communication with the image forming apparatus 2 via the firewall 5.

The input unit 48 is an example of a unit that receives an operation of the user on the server 4 and notifies the CPU 41 of the operation, and includes, for example, a button, a touch panel, a keyboard, a mouse, and a pointing device.

The display unit 49 is an example of a unit that visually displays information processed by the CPU 41, and includes, for example, a liquid crystal display and an organic EL display.

The computer 40 that functions as the server 4 may be realized by using a cloud service.

Next, the document storage process executed by the information processing system 1 will be described.

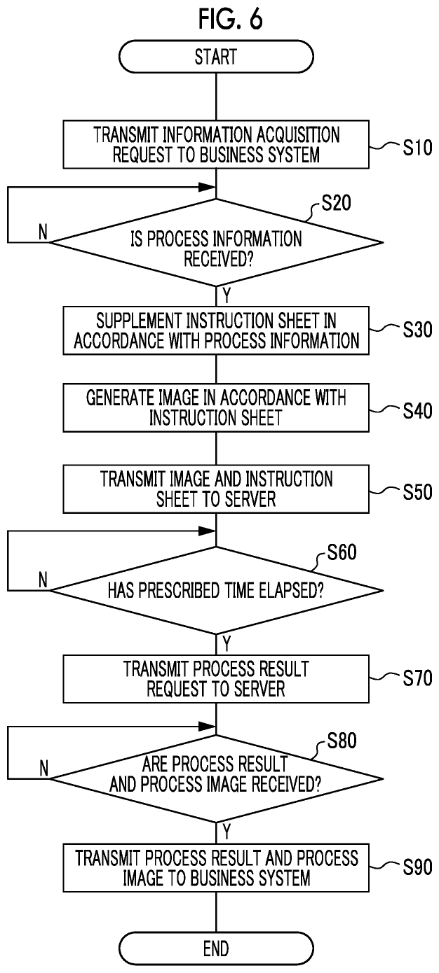

FIG. 6 is a flowchart illustrating an example of a flow of an image forming process executed by the CPU 11 of the image forming apparatus 2 in a case where an execution instruction to execute the document storage process is received from the user. An image forming program that defines the image forming process is stored in advance in, for example, the non-volatile memory 14 of the image forming apparatus 2. The CPU 11 of the image forming apparatus 2 reads the image forming program stored in the non-volatile memory 14 and executes the image forming process.

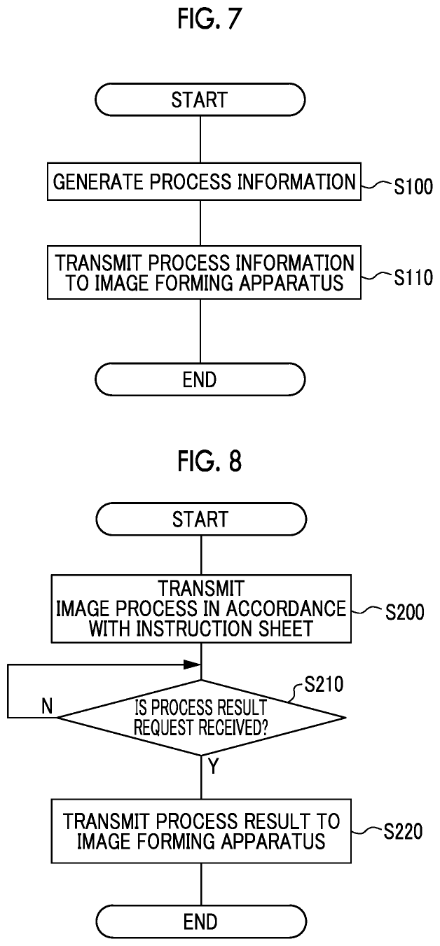

FIG. 7 is a flowchart illustrating an example of a flow of an information collection process executed by the CPU 31 of the business system 3, following the document storage process. A business program that defines the information collection process is stored in advance, for example, in the non-volatile memory 34 of the business system 3. The CPU 31 of the business system 3 reads the business program stored in the non-volatile memory 34 and executes the information collection process.

FIG. 8 is a flowchart illustrating an example of a flow of an image process executed by the CPU 41 of the server 4, following the document storage process. A server program that defines the image process is stored in advance in, for example, the non-volatile memory 44 of the server 4. The CPU 41 of the server 4 reads the server program stored in the non-volatile memory 44 and executes the image process.

It is assumed that the operation parameter of the scanner used in the document storage process and the information regarding the storage area as the candidate for the storage destination of the process image generated by the server 4 are set in advance in the business system 3, and are stored in the non-volatile memory 34, by the administrator, for example. The information regarding the storage area of the process image is information that defines the storage destination of the process image, and thus is an example of information having an influence on the operation of the document storage process. The storage area of the process image obtained by the image process on the server 4 will be referred to as a “storage area of a document” below.

In Step S10 of FIG. 6, the CPU 11 transmits an information acquisition request for acquiring the operation parameter of the scanner and the information regarding the storage area of the document to the business system 3 before scanning the document with the scanner.

In Step S100 of FIG. 7, the CPU 31 of the business system 3 that has received the information acquisition request collects the operation parameter corresponding to the document storage process and the information regarding the storage area of the document from the non-volatile memory 34, and generates process information.

For example, in a case where folder names named “estimation sheet”, “ordering sheet”, “delivery statement”, “invoice”, and “receipt” are stored in the non-volatile memory 34 as storage areas of documents, the CPU 31 generates process information including each folder name and the operation parameter corresponding to the document storage process. The folder name of the storage area of the document is an example of the name of the storage area of the document.

In Step S110, the CPU 31 controls the communication unit 37 to transmit the process information generated in Step S100 to the image forming apparatus 2 being a transmission source of the information acquisition request. Then, the CPU 31 ends the information collection process illustrated in FIG. 7.

On the other hand, while the business system 3 executes the information collection process, in Step S20 of FIG. 6, the CPU 11 in the image forming apparatus 2 that has transmitted the information acquisition request determines whether or not the process information has been received from the business system 3. In a case where the process information is not received, the CPU 11 repeatedly executes a determination process of Step S20 and waits until the process information is received from the business system 3. In a case where the process information has been received, the process proceeds to Step S30.

In Step S30, the CPU 11 supplements the content of the instruction sheet by reflecting the content of the process information in the instruction sheet corresponding to the document storage process. Specifically, the CPU 11 adds an instruction to set the operation parameter of the scanner, which is included in the process information, in the image forming apparatus 2 before scanning the document with the scanner, to the instruction sheet. Further, the CPU 11 adds an instruction to set the type of the document recognized by the OCR process of the server 4 as the type represented by the folder name of the storage area of the document, to the instruction sheet. Further, the CPU 11 adds an instruction to store the process result and the process image received from the server 4 in a folder of the business system 3 having the identical name to the type of the document included in the process result, to the instruction sheet.

Therefore, the instruction sheet for classifying the document scanned by the user with the scanner of the image forming apparatus 2 into storage areas of five types of document such as “estimation sheet”, “ordering sheet”, “delivery statement”, “invoice”, and “receipt” is completed.

As described above, the process information of the business system 3 supplements the content of the instruction sheet corresponding to the document storage process, and thus is an example of supplementary information.

In Step S40, the CPU 11 sets the operation parameter of the scanner to the operation parameter instructed in the instruction sheet, and then scans the document by the scanner to generate an image of the document.

In Step S50, the CPU 11 transmits, to the server 4, the supplemented an instruction sheet after supplementation in which the content is supplemented by using the process information together with the image generated in Step S40. Then, the CPU 11 instructs the server 4 to execute the image process on the image in accordance with the instruction sheet.

As a result, since the image process is executed in accordance with the instruction sheet by the server 4, the CPU 11 acquires the process result of the image process. However, since the image process in the server 4 takes time, in Step S60, the CPU 11 determines whether or not a prescribed time has elapsed after the image and the instruction sheet are transmitted to the server 4 in Step S50. The prescribed time is a time considered to be required for the server 4 to execute the image process instructed by the instruction sheet, and is stored in advance in the non-volatile memory 14 for each type of the image process. In the case of the example in the present disclosure, the CPU 11 determines whether or not the prescribed time associated with the OCR process of the image has elapsed.

In a case where the prescribed time has not elapsed, the CPU 11 repeatedly executes the determination process of Step S60 and waits until the prescribed time elapses. On the other hand, in a case where the prescribed time has elapsed, the process proceeds to Step S70.

In this case, it is considered that the image process in the server 4 has ended. Thus, in Step S70, the CPU 11 transmits a process result request for requesting the process result of the image process to the server 4.

On the other hand, the CPU 41 in the server 4 that has received the image and the instruction sheet executes the image process in accordance with the received instruction sheet, in Step S200 of FIG. 8. In the case of the example in the present disclosure, the CPU 41 executes the OCR process on the image, and identifies the type of document by recognizing which text of “estimation sheet”, “ordering sheet”, “delivery statement”, “invoice”, and “receipt” is included in the image subjected to the OCR process, that is, the process image. For example, in a case where the process image includes the text of “estimation sheet”, the CPU 41 identifies the type of the document indicated by the process image to be “estimation sheet”.

Therefore, in Step S210, the CPU 41 determines whether or not to receive the process result request from the image forming apparatus 2. In a case where the CPU 41 does not receive the process result request from the image forming apparatus 2, the CPU 41 repeatedly executes the determination process of Step S210 to monitor the reception of the process result request. On the other hand, in a case where the process result request is received, the process proceeds to Step S220.

In Step S220, the CPU 41 transmits the process result of the image process and the process image obtained by the image process to the image forming apparatus 2 being the transmission source of the process result request as a response of the process result request. Then, the CPU 41 ends the image process illustrated in FIG. 8. In the case of the example in the present disclosure, the process result includes the type of the document indicated by the process image. That is, the process result in the example in the present disclosure includes the name of the storage area representing the storage destination of the process image.

On the other hand, the CPU 11 in the image forming apparatus 2 determines whether or not to receive the process result and the process image from the server 4 in Step S80 after transmitting the process result request in Step S70 of FIG. 6. In a case where the process result and the process image are not received, the CPU 11 repeatedly executes the determination process of Step S80 and waits until the process result and the process image are received. The CPU 11 may transmit the process result request to the server 4 at predetermined intervals while waiting for reception of the process result and the process image. In a case where the process result and the process image are received from the server 4, the process proceeds to Step S90.

In Step S90, the CPU 11 transmits the process result and the process image to the storage area of the business system 3 having the identical name to the type of the document, which is included in the process result in accordance with the instruction sheet, thereby instructing the business system 3 to store the process result and the process image in the storage area being a transmission destination.

For example, in a case where the type of the document included in the process result is “estimation sheet”, the CPU 11 transmits the process result and the process image received from the server 4 to the folder of the business system 3 of which the folder name is “estimation sheet”. With the above description, the CPU 11 ends the image forming process illustrated in FIG. 6.

In such a document storage process, a process in a case where new “delivery form” is added as the type of document to be identified in addition to five types of documents such as “estimation sheet”, “ordering sheet”, “delivery statement”, “invoice”, and “receipt” is considered.

In the workflow process in the information processing system 1, a process in which an instruction sheet for the workflow process intended to be executed by the user is generated based on the process information acquired from the business system 3, and the business system 3 and the server 4 are instructed based on the instruction sheet generated by the image forming apparatus 2 is executed.

Therefore, for example, in a case where the administrator newly adds a folder having a folder name of “delivery form” to the business system 3, the business system 3 generates the process information including the folder name and the operation parameter of each folder including the added folder. Thus, the instruction sheet in which “delivery form” is added as the type of document to be recognized by the OCR process of the server 4 is generated.

That is, even though the administrator does not individually register information indicating that “delivery form” as an identification target of the document is added, in each of the image forming apparatus 2, the business system 3, and the server 4, by simply adding a folder having the folder name of “delivery form” to the business system 3, a point that the types of document to be identified by the server 4 are “estimation sheet”, “ordering sheet”, “delivery statement”, “invoice”, “receipt”, and “delivery form” is described in the instruction sheet. Therefore, the server 4 also identifies the document considered to be “delivery form”, and the image forming apparatus 2 stores the process image of the document recognized as “delivery form” in the designated storage area of the business system 3 (in this case, the folder having the folder name of “delivery form”).

### Second Exemplary Embodiment

In the first exemplary embodiment, the workflow process in the information processing system 1 has been described focusing on one image forming apparatus 2. However, as described above, the information processing system 1 may include a plurality of image forming apparatuses 2. In a second exemplary embodiment, a workflow process in a case where the information processing system 1 includes a plurality of image forming apparatuses 2 will be described.

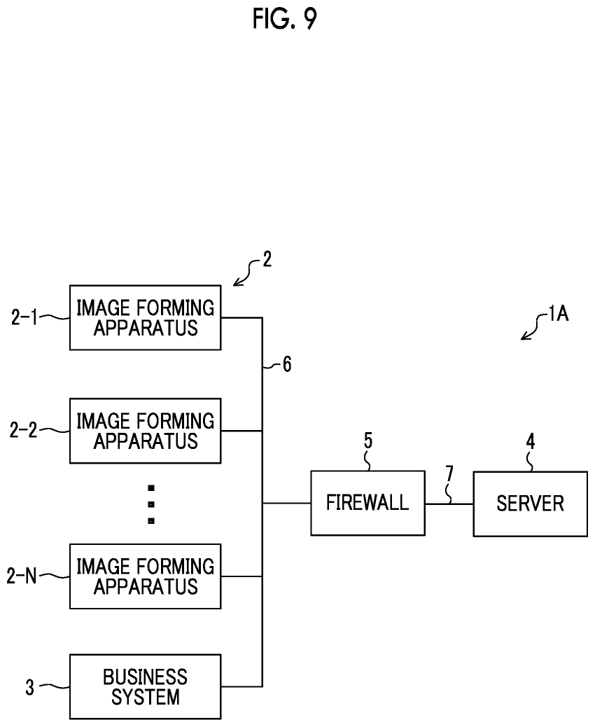

FIG. 9 is a diagram illustrating a system configuration example in an information processing system 1A according to a second exemplary embodiment. The information processing system 1A illustrated in FIG. 9 is different from the system configuration example of the information processing system 1 in the first exemplary embodiment illustrated in FIG. 1 in that a plurality of image forming apparatuses 2-1 to 2-N (where N is a natural number) is installed on the inside of the firewall 5, and each of the image forming apparatuses 2-1 to 2-N is connected to the communication line 6. For convenience of description, the image forming apparatuses 2-1 to 2-N will be collectively referred to as the “image forming apparatus 2”.

As an example, the information processing system 1A illustrated in FIG. 9 has a system configuration in which each image forming apparatus 2 is installed in a different branch office, and the business system 3 and the firewall 5 are installed in a head office.

In the information processing system 1A having such a system configuration, the server 4 may execute a document storage process of aggregating process images of the document in the respective branch offices in the business system 3 of the head office in a manner that the server 4 executes an OCR process on an image of a document scanned by the scanner of the image forming apparatus 2 in each branch office, and scans the content of a specific item included in the image, and the image forming apparatus 2 stores the document in a storage area corresponding to the content of the scanned item, which is provided in the business system 3 in advance.

A document storage process according to the second exemplary embodiment is also executed in accordance with the data flow in the workflow process illustrated in FIG. 2. Specifically, the document storage process according to the second exemplary embodiment is executed in a manner that the image forming apparatus 2, the business system 3, and the server 4 execute the image forming process illustrated in FIG. 6, the information collection process illustrated in FIG. 7, and the image process illustrated in FIG. 8, respectively.

As an example, the document storage process of scanning the content of an item “the name of the financial company of the business partner” included in each document and storing each document in the storage area of the business system 3 provided for each financial company of the business partner will be described with reference to FIGS. 6 to 8.

The configuration of the main part of the electrical system of the image forming apparatus 2, the business system 3, and the server 4 in the information processing system 1A is identical to the configuration example of the main part of the electrical system of the image forming apparatus 2, the business system 3, and the server 4 according to the first exemplary embodiment illustrated in FIGS. 3 to 5, respectively.

In Step S10 of FIG. 6, the CPU 11 transmits an information acquisition request for acquiring the operation parameter of the scanner and the information regarding the storage area of the document to the business system 3 before scanning the document with the scanner.

In Step S100 of FIG. 7, the CPU 31 of the business system 3 that has received the information acquisition request collects the operation parameter corresponding to the document storage process and the information regarding the storage area of the document from the non-volatile memory 34, and generates process information.

For example, in a case where folder names named “Bank A”, “B Insurance company”, and “C Trust bank” are stored as storage areas for documents in the non-volatile memory 34, the CPU 31 generates process information including the respective folder name and the operation parameters.

In Step S110, the CPU 31 controls the communication unit 37 to transmit the process information generated in Step S100 to the image forming apparatus 2 being a transmission source of the information acquisition request. Then, the CPU 31 ends the information collection process illustrated in FIG. 7.

On the other hand, while the business system 3 executes the information collection process, in Step S20 of FIG. 6, the CPU 11 in the image forming apparatus 2 that has transmitted the information acquisition request determines whether or not the process information has been received from the business system 3. In a case where the process information is not received, the CPU 11 repeatedly executes a determination process of Step S20 and waits until the process information is received from the business system 3. In a case where the process information has been received, the process proceeds to Step S30.

In Step S30, the CPU 11 supplements the content of the instruction sheet by reflecting the content of the process information in the instruction sheet corresponding to the document storage process. Specifically, the CPU 11 adds an instruction to set the operation parameter of the scanner, which is included in the process information, in the image forming apparatus 2 before scanning the document with the scanner, to the instruction sheet. The CPU 11 adds an instruction to set the item for which the content is scanned by the OCR process of the server 4 to be “the name of the financial company of the business partner” to the instruction sheet. Further, the CPU 11 adds an instruction to store the process result and the process image received from the server 4 in a folder of the business system 3 having the identical name to the name of the financial company included in the process result, to the instruction sheet.

Accordingly, the instruction sheet for classifying and storing the document scanned by the user with the scanner in the image forming apparatus 2 into storage areas of three types of documents named “Bank A”, “B Insurance company”, and “C Trust bank” in accordance with the name of the financial company of the business partner is completed.

In Step S40, the CPU 11 sets the operation parameter of the scanner to the operation parameter designated in the instruction sheet, and then scans the document by the scanner to generate an image of the document.

In Step S50, the CPU 11 transmits, to the server 4, the supplemented an instruction sheet after supplementation in which the content is supplemented by using the process information together with the image generated in Step S40. Then, the CPU 11 instructs the server 4 to execute the image process on the image in accordance with the instruction sheet.

In Step S60, the CPU 11 determines whether or not a prescribed time has elapsed after the image and the instruction sheet are transmitted to the server 4 in Step S50.

In a case where the prescribed time has not elapsed, the CPU 11 repeatedly executes the determination process of Step S60 and waits until the prescribed time elapses. On the other hand, in a case where the prescribed time has elapsed, the process proceeds to Step S70.

In this case, it is considered that the image process in the server 4 has ended. Thus, in Step S70, the CPU 11 transmits a process result request for requesting the process result of the image process to the server 4.

On the other hand, the CPU 41 in the server 4 that has received the image and the instruction sheet executes the image process in accordance with the received instruction sheet, in Step S200 of FIG. 8. In the case of the example in the present disclosure, the CPU 41 executes the OCR process on the image to extract an item of “the name of the financial company of the business partner” from the image subjected to the OCR process, that is, the process image, and to scan text described in the item of “the name of the financial company of the business partner”. In this state, the CPU 41 recognizes which of the texts “Bank A”, “B Insurance company”, and “C Trust bank” is described in the item of “the name of the financial company of the business partner” and acquires the name of the financial company of the business partner from the process image.

In Step S220, the CPU 41 transmits the process result of the image process and the process image obtained by the image process to the image forming apparatus 2 being the transmission source of the process result request as a response of the process result request. Then, the CPU 41 ends the image process illustrated in FIG. 8. In the case of the example in the present disclosure, the process result includes the name of the financial company of the business partner described in the document. That is, the process result in the example in the present disclosure includes the name of the storage area representing the storage destination of the process image.

On the other hand, the CPU 11 in the image forming apparatus 2 determines whether or not to receive the process result and the process image from the server 4 in Step S80 after transmitting the process result request in Step S70 of FIG. 6. In a case where the process result and the process image are not received, the CPU 11 repeatedly executes the determination process of Step S80 and waits until the process result and the process image are received. In a case where the process result and the process image are received from the server 4, the process proceeds to Step S90.

In Step S90, the CPU 11 transmits the process result and the process image to the storage area of the business system 3 having the identical name to the name of the financial company of the business partner, which is included in the process result in accordance with the instruction sheet, thereby instructing the business system 3 to store the process result and the process image in the storage area being a transmission destination.

For example, in a case where the name of the financial company of the business partner included in the process result is “A Bank”, the CPU 11 transmits the process result and the process image received from the server 4 to the folder of the business system 3, which has the folder name of “A Bank”. With the above description, the CPU 11 ends the image forming process illustrated in FIG. 6.

In such a document storage process, a process in a case where “D Credit Union” which has newly started a transaction is added as the type of document to be identified in addition to three types of financial companies of the business partners such as “A Bank”, “B Insurance company”, and “C Trust bank” is considered.

As described above, in the workflow process in the information processing system 1, a process in which an instruction sheet for the workflow process intended to be executed by the user is generated based on the process information acquired from the business system 3, and the business system 3 and the server 4 are instructed based on the instruction sheet generated by the image forming apparatus 2 is executed.

Therefore, for example, in a case where the administrator newly adds a folder having a folder name of “D Credit Union” to the business system 3, the business system 3 generates the process information including the folder name and the operation parameter of each folder including the added folder. Thus, an instruction sheet in which “D Credit Union” is added as the content of the item of “the name of the financial name of the business partner” recognized by the OCR process of the server 4 is generated.

That is, even though the administrator does not individually register information indicating that “D Credit Bank” has been added as a new business partner to each of the image forming apparatus 2, the business system 3, and the server 4, by simply adding a folder having a folder name of “D Credit Union” to the business system 3, a point that “A Bank”, “B Insurance company”, and “C Trust bank”, and “D Credit Union” is included in the item of “the name of the financial name of the business partner” is described in the instruction sheet. Therefore, the server 4 recognizes the document in which “D Credit Union” is described in the item of “the name of the financial name of the business partner”. In addition, the image forming apparatus 2 stores the process image of the document in which “D credit union” is described in the item of “the name of the financial name of the business partner”, in the designated storage area (in this case, the folder having the folder name “D Credit Union”).

As described above, according to the information processing systems 1 and 1A of the present disclosure, the content of the instruction sheet corresponding to the workflow process is updated only by reflecting the change content for the workflow process in the business system 3. Each apparatus included in the information processing systems 1 and 1A executes the process according to the updated instruction sheet.

In the example of the present disclosure, the instruction sheet is generated by supplementing the instruction sheet corresponding to the execution instruction of the user already existing in the image forming apparatus 2 based on the content of the process information received from the business system 3 by the image forming apparatus 2. The method of generating the instruction sheet is not limited to this.

For example, the image forming apparatus 2 transmits an instruction acquisition request for acquiring an instruction sheet corresponding to the process instructed by the user to the business system 3 without generating the instruction sheet. On the other hand, the business system 3 collects operation parameters preset for the instructed process and information necessary for executing the instructed process, and collects the collected operation parameters and information. An instruction sheet for processing instructed to be reflected may be generated, and the generated instruction sheet may be transmitted to the image forming apparatus 2. In this case, the image forming apparatus 2 and the server 4 may execute each process in accordance with the instruction sheet generated by the business system 3.

Although one aspect of the information processing system 1 has been described above using the exemplary embodiments, the disclosed form of the information processing system 1 is an example, and the form of the information processing system 1 is not limited to the scope described in the exemplary embodiment. Various changes or improvements may be made to the exemplary embodiments without departing from the gist of the present disclosure, and the changed or improved modes are also included in the technical scope of the present disclosure. For example, the internal processing order in each process such as the image forming process illustrated in FIG. 6, the information collection process illustrated in FIG. 7, and the image process illustrated in FIG. 8 may be changed without departing from the gist of the present disclosure.

Further, in the above-described exemplary embodiments, as an example, a mode in which each process illustrated in FIGS. 6 to 8 is realized by software has been described. However, the processes equivalent to the flowcharts may be processed by hardware. In this case, the speed of the process can be increased as compared to the case where each process is realized by software.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In the above exemplary embodiments, an example in which the image forming program is stored in the non-volatile memory 14, the business program is stored in the non-volatile memory 34, and the server program is stored in the non-volatile memory 44 has been described. However, the storage destination of each program is not limited to the non-volatile memory 14, the non-volatile memory 34, and the non-volatile memory 44.

The image forming program according to the present disclosure can also be provided in a form of being recorded on a storage medium readable by the computer 10. The business program in the present disclosure can also be provided in a form of being recorded on a storage medium readable by the computer 30. The server program in the present disclosure can also be provided in a form of being recorded on a storage medium readable by the computer 40.

For example, the image forming program, the business program, and the server program may be provided in a form of being recorded on an optical disc such as a compact disk read only memory (CD-ROM) and a digital versatile disk read only memory (DVD-ROM). The image forming program, the business program, and the server program may be provided in a form in which the information processing program is recorded in a portable semiconductor memory such as a universal serial bus (USB) memory and a memory card. The ROM 12, the ROM 32, the ROM 42, the non-volatile memory 14, the non-volatile memory 34, the non-volatile memory 44, the CD-ROM, the DVD-ROM, the USB, and the memory card are examples of the non-transitory storage medium.

Further, the image forming apparatus 2 may download the image forming program from an external device (not illustrated) connected to the communication line 6 or the communication line 7 through the communication unit 17, and store the downloaded image forming program in a storage device. The business system 3 may download the business program from an external device through the communication unit 37 and store the downloaded business program in a storage device. The server 4 may also download the server program from an external device through the communication unit 47 and store the downloaded server program in a storage device.

In this case, the CPU 11 of the image forming apparatus 2 reads the image forming program downloaded from the external device from the storage device and executes the image forming process. The CPU 31 of the business system 3 reads the business program downloaded from the external device from the storage device and executes the information collection process. The CPU 41 of the server 4 reads the server program downloaded from the external device from the external device from the storage device and executes the image process.

The supplementary notes according to the present exemplary embodiment are described below.

(((1)))

An image forming apparatus comprising:
a processor configured to:
   acquire supplementary information for supplementing a process instructed in an instruction sheet from a first server installed together on an inside of a firewall;
   execute the process instructed in accordance with the instruction sheet supplemented by the supplementary information; and
   transmit the supplemented instruction sheet to a second server installed on an outside of the firewall together with an image generated by the instructed process, and instruct the second server to execute an image process on the image in accordance with the instruction sheet.

(((2)))

The image forming apparatus according to (((1))),
wherein the supplementary information includes a content of a change in information having an influence on an operation of the instructed process, the information being retained by the first server.

(((3)))

The image forming apparatus according to (((2))),
wherein the information having the influence on the operation of the instructed process is information regarding a storage area of data as a candidate for a storage destination of a process image obtained by executing the image process on the image.

(((4)))

The image forming apparatus according to (((3))),
wherein the information regarding the storage area is a name of the storage area, and the processor is configured to:
   supplement the instruction sheet in accordance with the supplementary information to cause the second server to recognize which name of the storage area is included in the image.

(((5)))

The image forming apparatus according to (((4))), wherein the processor is configured to:
receive the process image from the second server together with the name of the storage area representing the storage destination of the process image; and
transmit the process image to the first server and instruct the first server to store the process image in a storage area indicated by the name of the storage area.

(((6)))

A non-transitory computer readable medium storing a program capable of being executed by a computer installed on an inside of a firewall to execute an image forming process comprising:
acquiring supplementary information for supplementing a process instructed in an instruction sheet from a first server installed together on the inside of the firewall;
executing the process instructed in accordance with the instruction sheet supplemented by the supplementary information; and
transmitting the supplemented instruction sheet to a second server installed on an outside of the firewall together with an image generated by the instructed process, and instructing the second server to execute an image process on the image in accordance with the instruction sheet.

(((7)))

An information processing system comprising:
an image forming apparatus and a first server installed together on an inside of a firewall; and
a second server installed on an outside of the firewall,
wherein the first server includes a first processor configured to:
   store supplementary information for supplementing a process instructed in an instruction sheet in a storage device,
the image forming apparatus includes a second processor configured to:
   acquire the supplementary information from the first server;
   execute the process instructed in accordance with the instruction sheet supplemented by the supplementary information; and
   transmit the supplemented instruction sheet together with an image generated by the instructed process to the second server installed on the outside of the firewall, and
the second server includes a third processor configured to:
   execute an image process on the image in accordance with the instruction sheet.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a processor configured to:
acquire supplementary information for supplementing a process instructed in an instruction sheet from a first server installed together on an inside of a firewall;
execute the process instructed in accordance with the instruction sheet supplemented by the supplementary information; and
transmit the supplemented instruction sheet to a second server installed on an outside of the firewall together with an image generated by the instructed process, and instruct the second server to execute an image process on the image in accordance with the instruction sheet.

2. The image forming apparatus according to claim 1,
wherein the supplementary information includes a content of a change in information having an influence on an operation of the instructed process, the information being retained by the first server.

3. The image forming apparatus according to claim 2,
wherein the information having the influence on the operation of the instructed process is information regarding a storage area of data as a candidate for a storage destination of a process image obtained by executing the image process on the image.

4. The image forming apparatus according to claim 3,
wherein the information regarding the storage area is a name of the storage area, and
the processor is configured to:
supplement the instruction sheet in accordance with the supplementary information to cause the second server to recognize which name of the storage area is included in the image.

5. The image forming apparatus according to claim 4, wherein the processor is configured to:
receive the process image from the second server together with the name of the storage area representing the storage destination of the process image; and
transmit the process image to the first server and instruct the first server to store the process image in a storage area indicated by the name of the storage area.

6. A non-transitory computer readable medium storing an image forming program causing a computer installed on an inside of a firewall to execute a process comprising:
acquiring supplementary information for supplementing a process instructed in an instruction sheet from a first server installed together on the inside of the firewall;
executing the process instructed in accordance with the instruction sheet supplemented by the supplementary information; and
transmitting the supplemented instruction sheet to a second server installed on an outside of the firewall together with an image generated by the instructed process, and instructing the second server to execute an image process on the image in accordance with the instruction sheet.

7. An information processing system comprising:
an image forming apparatus and a first server installed together on an inside of a firewall; and
a second server installed on an outside of the firewall,
wherein the first server includes a first processor configured to:
store supplementary information for supplementing a process instructed in an instruction sheet in a storage device,
the image forming apparatus includes a second processor configured to:
acquire the supplementary information from the first server;
execute the process instructed in accordance with the instruction sheet supplemented by the supplementary information; and
transmit the supplemented instruction sheet together with an image generated by the instructed process to the second server installed on the outside of the firewall, and
the second server includes a third processor configured to:
execute an image process on the image in accordance with the instruction sheet.
